(19) United States
(12) Patent Application Publication
(10) Pub. No.: US 2013/0197978 A1
(43) Pub. Date: Aug. 1, 2013

(54) METHOD AND APPARATUS TO REWARD USERS OF CONTENT AND HOSTING APPLICATIONS

(71) Applicant: Hai Bui, Santa Clara, CA (US)

(72) Inventor: Hai Bui, Santa Clara, CA (US)

(73) Assignee: Adobe Systems, Inc.

(21) Appl. No.: 12/250,726

(22) Filed: Oct. 14, 2008

(51) Int. Cl. G06Q 30/02

(52) U.S. Cl. 705/14.1; 705/14.3

(57) ABSTRACT

A method, apparatus and computer program product for rewarding users of content and hosting applications is presented. Content is accessed using a hosting application. The presence of a reward code within the content is determined and the user is rewarded for accessing the content with the hosting application. The reward is provided by either the content provider or by the hosting application provider.

### BACKGROUND

There are several different types of content available for users to view on their computers. These different types of content include text files, image files, audio files, video files, web sites, executable files (e.g., scripts and computer programs) and the like. Concomitantly, there are also a wide variety of applications (sometimes referred to herein as hosting applications) to view such content. For example, a user has a choice among several different hosting applications from different vendors to use in order to view a video file.

Content providers may prefer to have clients or customers view a particular type of content (e.g., online content) rather than another type of content (e.g., printed records). For example, a financial institution may prefer to have monthly statements available online such that the account owner can log-in and view their account rather than go through the time, labor and cost of providing a hard copy of monthly statements and mailing them to customers each month. In another example, a hosting application provider can provide a reward program as an incentive for its customers to read electronic documents in Portable Document Format (PDF®) instead of Hyper Text Markup Language (HTML) format, or another competitive electronic document format to PDF.

### SUMMARY

Conventional mechanisms such as those explained above suffer from a variety of deficiencies. One such deficiency is that there may be little or no incentive for a user to view a certain type of content or to utilize a particular hosting application to view content. A user selects a particular hosting application to view content for any number of reasons, such as using the default application for a particular file type, or using a hosting application the user is already familiar with. Similarly, a user is provided with little or no incentive to access a particular type of content rather than another type of content.

Embodiments of the invention significantly overcome such deficiencies and provide mechanisms and techniques that provide an incentive for a user to use a particular application to access content or to view a particular type of content.

In a particular embodiment of a method for rewarding users of content, the method includes accessing content with a hosting application. The method further includes determining a presence of a reward code within the content and awarding a reward to a user for accessing the content. The reward is offered by the provider of the content being viewed with the hosting application, such that users are rewarded by the content provider for viewing a particular type of content.

In another particular embodiment of a method for rewarding users of hosting applications, the method includes accessing content with a hosting application. The method further includes determining a presence of a reward code within the content and awarding a reward to a user for accessing the content with the application. The reward is offered by the provider of the hosting application such that users are rewarded by the hosting application provider for viewing content.

In still another particular embodiment of a method for rewarding users of content the method includes producing content. The method further includes embedding a reward code within the content wherein the content is capable of being accessed by a user, who will receive a reward for accessing the content. Again, the reward is offered by the provider of the content being viewed with the hosting application. In such a manner the user is rewarded by the content provider for viewing a particular type of content.

In yet another particular embodiment of a method for rewarding users of hosting applications, the method includes producing content. The method further includes embedding a reward code within the content wherein the content is capable of being accessed by a user, who will receive a reward for accessing the content with the hosting application. Again, the reward is offered by the provider of the hosting application. In such a manner the user is rewarded by the hosting application provider for viewing content with the hosting application.

Other embodiments include a computer readable medium having computer readable code thereon for rewarding users of content. The computer readable medium includes instructions for accessing content with a hosting application. The computer readable medium further includes instructions for determining a presence of a reward code within the content and instructions for awarding a reward to a user for accessing the content. The reward is offered by the provider of the content being viewed with the hosting application, such that users are rewarded by the content provider for viewing a particular type of content.

Still other embodiments include a computer readable medium having computer readable code thereon for rewarding users of hosting applications. The computer readable medium includes instructions for accessing content with a hosting application. The computer readable medium further includes instructions for determining a presence of a reward code within the content and instructions for awarding a reward to a user for accessing the content with the application. The reward is offered by the provider of the hosting application such that users are rewarded by the hosting application provider for viewing content.

Still other embodiments include a computer readable medium having computer readable code thereon for rewarding users of content. The computer readable medium includes instructions for producing content. The computer readable medium further includes instructions for including a reward code within the content wherein the content is capable of being accessed by a user, the user receiving a reward for accessing the content. Again, the reward is offered by the provider of the content being viewed with the hosting application. In such a manner users are rewarded by the content provider for viewing a particular type of content.

Yet other particular embodiments include a computer readable medium having computer readable code thereon for rewarding users of hosting applications. The computer readable medium includes instructions for producing content. The computer readable medium further includes instructions for including a reward code within the content wherein the content is capable of being accessed by a user, the user receiving a reward for accessing the content with the hosting application. Again, the reward is offered by the provider of the hosting application. In such a manner users are rewarded by the hosting application provider for viewing content with the hosting application.

Another embodiment includes enabling merchants to advertise for branding and promoting their business by paying a fee to the hosting application provider to have their items of value (e.g., gift cards) listed as one of the redemption choices.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides rewards for users of content and hosting applications explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing rewards to users of content and hosting applications as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more persistent or volatile storage or programmable components or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a set of dedicated computers.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Adobe Systems Incorporated of San Jose, Calif.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. These drawings are also not finalized implementations, and are subjects for future modifications and improvements.

FIG. 1 depicts a screen shot of a user viewing content from a content provider;

FIG. 2 depicts a screen shot of a user using an application from an application provider to view content;

FIG. 3 depicts a flow diagram of a particular embodiment of a method for viewing content from a content provider;

FIG. 4 depicts a flow diagram of a particular embodiment of a method for viewing content using a hosting application;

FIG. 5 depicts a flow diagram of a particular embodiment of a method for providing a reward code within content;

FIG. 6 depicts a flow diagram of a particular embodiment of a method for providing a reward code within content for use by a hosting application; and

FIG. 7 illustrates an example computer system architecture for a computer system that rewards users of content and hosting applications in accordance with embodiments of the invention.

### DETAILED DESCRIPTION

A hosting application is an application that is used to view content. For example, a Flash® animation file is content can be viewed by way of the Adobe Flash Player® (available from Adobe Systems Incorporated, of San Jose, Calif.). Similarly, a Portable Document Format (PDF®) file is content that can be viewed with Adobe Reader (also available from Adobe Systems Incorporated, of San Jose, Calif.) or an Adobe® AIR™ application is run within the Adobe® AIR™ runtime. There are also other hosting applications that can be used to view content. The Flash animation and PDF files can also be viewed by applications from other providers, thus there is competition between the hosting application providers to convince the user to select their particular hosting application to view content. One way to convince a user to use a certain hosting application to view content is by offering the user a reward.

Content can be made available by content providers in different formats, having different costs associated therewith. In an effort to reduce costs a content provider may prefer that content be viewed in one format as opposed to other formats. For example, there is currently a strong demand for electronic forms, such as from phone companies, cable television companies, and different banks trying to persuade customers to read their monthly statements online instead of receiving them by mail.

The hosting application enables implementation of a rewards program to promote use of either the hosting application to view content or to promote the use of a certain type of content. When the hosting application is used to view content that contains a reward code, the user is credited with a predetermined amount value (e.g., a number of points). The reward amounts are posted to the current application user's account, which requires the user to have opened, and signed in when a reward is credited. The reward code is embedded into the content by the content author or the hosting application's creator. The reward is redeemable for an item of value, such as a gift card.

An example is described below, note that the following is only one example, and is not intended to limit the present invention. In this example, Bank A wants to drive adoption of electronic statements, so Bank A announces that it will encode its statements with a special code. If any of Bank A's customers downloads these statements and views them using a particular hosting application (e.g., Adobe Reader) the customer will be prompted by the hosting application to open a reward account (if they haven't already signed up), sign in, and are rewarded with a certain number of points the first time the document is read. The hosting application reads the specially-coded content, and then credits the points to the user's account.

A similar mechanism is used for rewards offered by hosting application providers. When content is viewed using the particular hosting application, the hosting application includes code that recognizes the awards code within the content and provides the reward crediting, balance reporting, and redemption options to the user of the hosting application.

In a particular example, the reward code inside the content includes an Issuer ID to identify the rewards provider, the amount of award, and a validation (e.g., a Message-Digest algorithm 5 (MD5)) signature to ensure the special promotion has not been compromised).

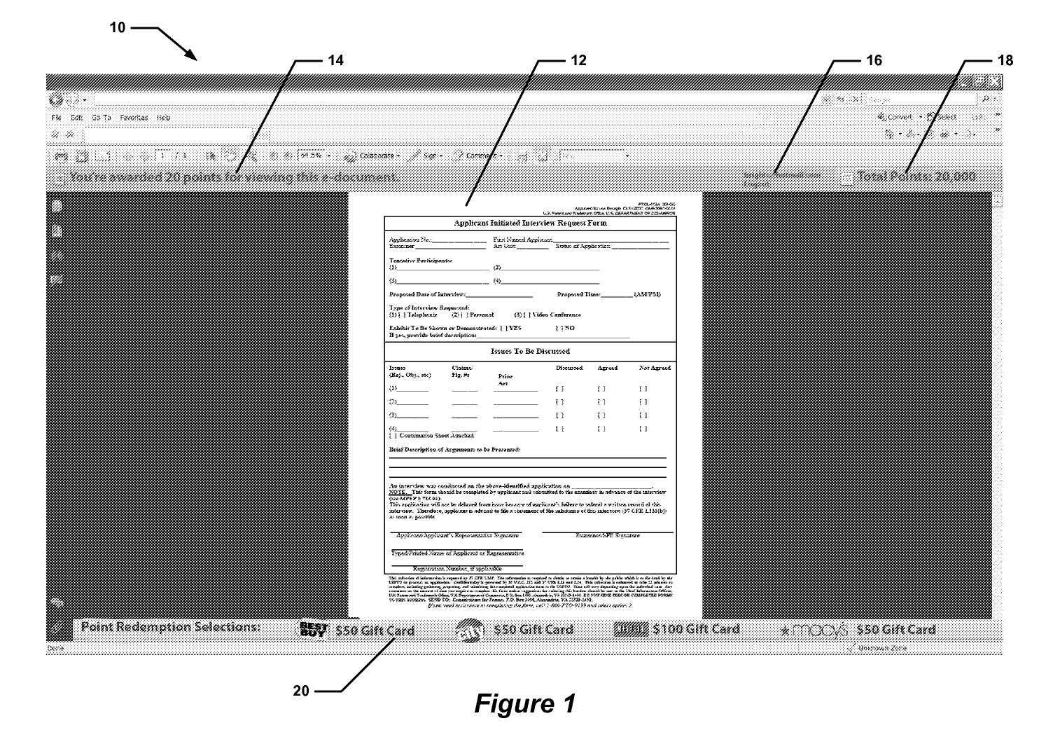

Referring now to FIG. 1, a screenshot of an example graphical user interface (GUI) 10 of a user viewing content from a content provider is shown. In this example, the content being viewed is a document 12, though it should be appreciated that other types of content (includes text files, image files, audio files, video files, web sites and the like) could also be viewed. Here the user is rewarded for viewing the document by the content provider.

Reward notice 14 shows that the user is being awarded a total of 20 points for viewing the document. The user is rewarded the first time the content is viewed. The user has previously registered with the content provider and the award amount is added to the users total. In this example, the user is shown in field 16 as brightc@hotmail.com. Field 18 shows the users total amount of points (20,000 in this example). Also shown are various point redemption selections available to the user. In this example, the user can redeem the 20,000 accumulated points towards a gift card from certain vendors. Also shown is a reward point redemption bar 20. The user can click on the desired award within reward point redemption bar 20 and redeem the accumulated points for the gift card, which will be supplied to the user. The gift card may be presented for printing, may be mailed to the user or the user may be directed to the vendor's website along with a gift card code.

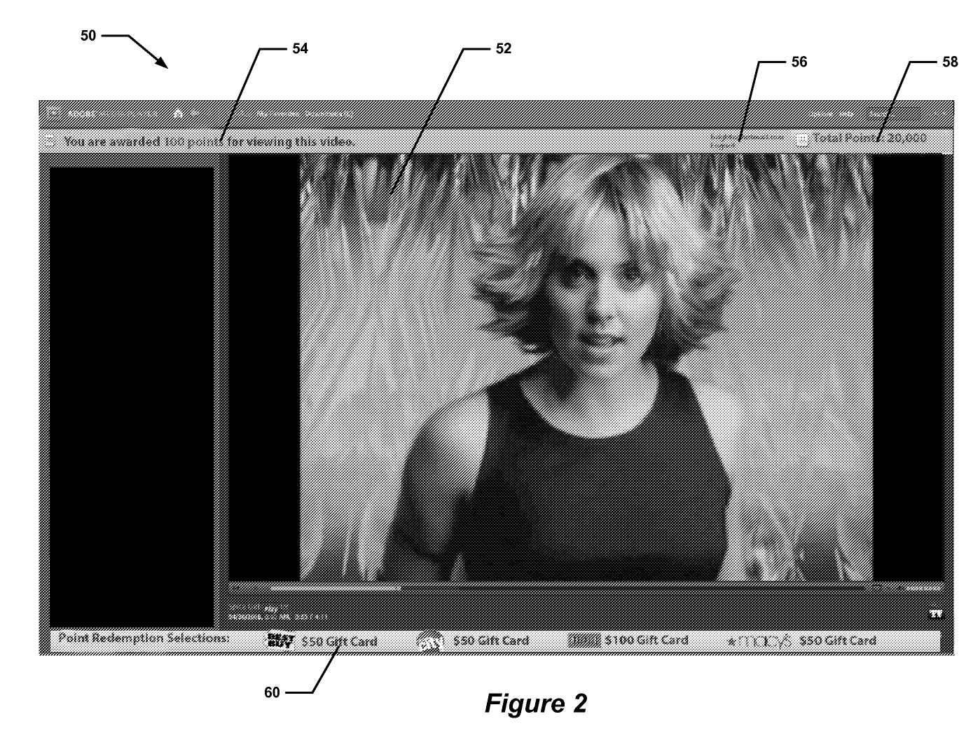

Referring now to FIG. 2, a screenshot of a graphical user interface (GUI) 50 of a user viewing content using a hosting application from an application provider is shown. In this example, the content being viewed is a video 52, though it should be appreciated that other types of content (includes text files, image files, audio files, video files, web sites and the like) could also be viewed. Here the user is rewarded for viewing the content using the particular hosting application.

Reward notice 54 shows that the user is being awarded a total of 100 points for viewing the content with the hosting application. The user is rewarded the first time the content is viewed with the particular hosting application. The user has previously registered with the hosting application provider and the award amount is added to the user's total. In this example, the user is shown in field 56 as brightc@hotmail.com. Field 58 shows the users total amount of points (20,000 in this example). Also shown is a reward point redemption bar 60. In this example, the user can redeem the 20,000 accumulated points towards a gift card from certain vendors. The user can click on the desired award within reward point redemption bar 60 and redeem the accumulated points for the gift card, which will be supplied to the user.

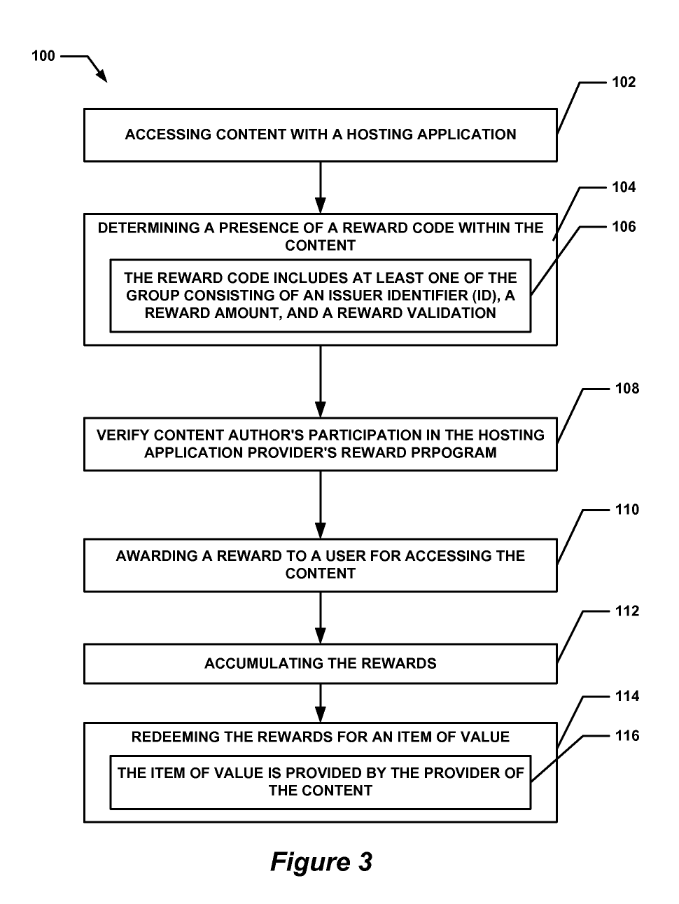

Flow diagrams of the presently disclosed methods are depicted in FIGS. 3 through 6. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 3, a particular embodiment of a method for rewarding a user of content 100 is shown. Method 100 starts with processing block 102 which discloses accessing content with a hosting application. The content includes text files, image files, audio files, video files, web sites and the like.

Processing block 104 states determining a presence of a reward code within the content. As shown in processing block 106, the reward code includes at least one of the group consisting of an issuer identifier (ID), a reward amount, and a reward validation. The issuer ID to identify the rewards provider, the reward amount indicates the amount of the award, and the reward validation (e.g., a Message-Digest algorithm 5 (MD5)) is used to ensure the special promotion has not been compromised.

Processing block 108 recites verify the content author's participation in the hosting application provider's reward program. The hosting application uses the embedded data to check back with the hosting application provider's registry to verify the content author's registration to the reward program.

Processing block 110 states awarding a reward to a user for accessing the content. The user is prompted by the hosting application to open a reward account (if they haven't signed up), and then sign in, and then are rewarded with a certain number of points the first time the content is viewed. The hosting application reads the specially-coded content, and then credits the points to the user's account.

Processing continues with processing block 112 which discloses accumulating the rewards. The reward received for viewing the content is added to the balance in the user's account.

Processing block 114 states redeeming the rewards for an item of value. Processing block 116 recites wherein the item of value is provided by the provider of the content. Various point redemption selections may be made available to the user. For example, the user can redeem the accumulated points towards a gift card from certain vendors.

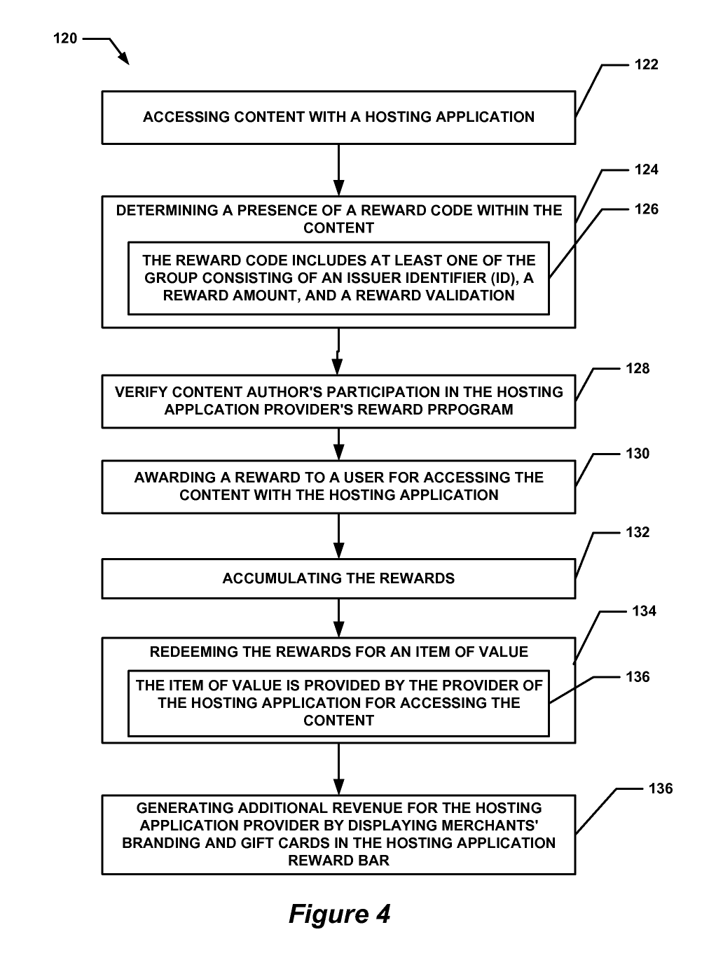

Referring now to FIG. 4, a particular embodiment of a method for rewarding a user of a hosting application 120 is shown. Method 120 starts with processing block 122 which discloses accessing content with a hosting application. The content includes text files, image files, audio files, video files, web sites and the like.

Processing block 124 states determining a presence of a reward code within the content. As shown in processing block 126, the reward code includes at least one of the group consisting of an issuer identifier (ID), a reward amount, and a reward validation. The issuer ID to identify the rewards provider, the reward amount indicates the amount of the award, and the reward validation (e.g., a Message-Digest algorithm 5 (MD5)) is used to ensure the special promotion has not been compromised.

Processing block 128 recites verify the content author's participation in the hosting application provider's reward program. The hosting application uses the embedded data to check back with the hosting application provider's registry to verify the content author's registration to the reward program.

Processing block 130 recites awarding a reward to a user for accessing the content with the hosting application. The user is prompted by the hosting application to open a reward account (if they haven't signed up), sign in, and is rewarded with a certain number of points the first time the content is viewed. The hosting application reads the specially-coded content, and then credits the points to the user's account.

Processing continues with processing block 132 which discloses accumulating the rewards. The reward received for viewing the content is added to the balance in the user's account.

Processing block 134 states redeeming the rewards for an item of value. Processing block 136 recites wherein the item of value is provided by the provider of the hosting application for accessing the content. Various point redemption selections may be made available to the user. For example, the user can redeem the accumulated points towards a gift card from certain vendors.

Processing block 138 discloses generating additional revenue for the hosting application provider by displaying merchants' branding and gift cards in the hosting application reward bar. The items displayed as potential rewards are placed in the reward bar in exchange for a fee received from the reward provider to the hosting application provider.

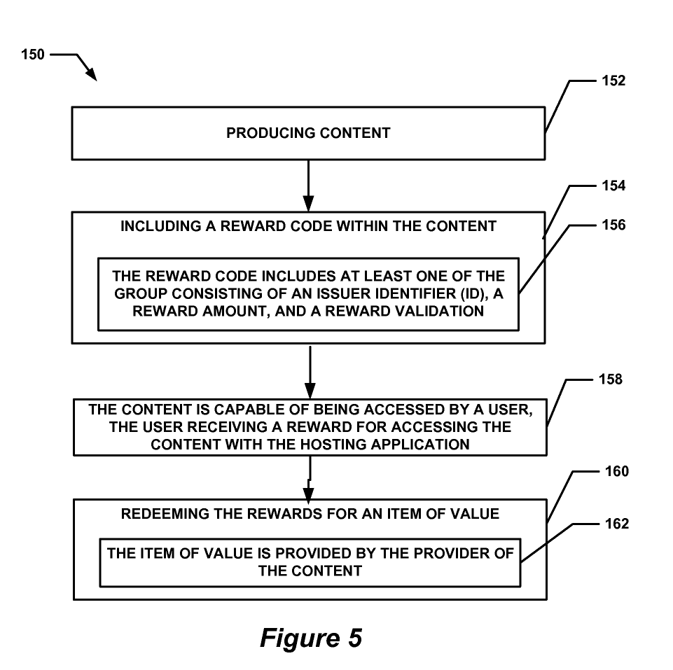

Referring now to FIG. 5, a particular embodiment of a method for rewarding a user of content 150 is shown. Method 150 starts with processing block 152 which discloses producing content. The content includes text files, image files, audio files, video files, web sites and the like.

Processing block 154 states including a reward code within the content. As shown in processing block 156, the reward code includes at least one of the group consisting of an issuer identifier (ID), a reward amount, and a reward validation. The issuer ID to identify the rewards provider, the reward amount indicates the amount of the award, and the reward validation (e.g., a Message-Digest algorithm 5 (MD5)) is used to ensure the special promotion has not been compromised.

Processing block 158 discloses the content is capable of being accessed by a user, the user receiving a reward for accessing the content. The user is prompted by the hosting application to open a reward account (if they haven't signed up), sign in, and is rewarded with a certain number of points the first time the content is viewed. The hosting application reads the specially-coded content, and then credits the points to the user's account.

Processing block 160 states redeeming the rewards for an item of value. Processing block 162 recites wherein the item of value is provided by the provider of the content. Various point redemption selections may be made available to the user. For example, the user can redeem the accumulated points towards a gift card from certain vendors.

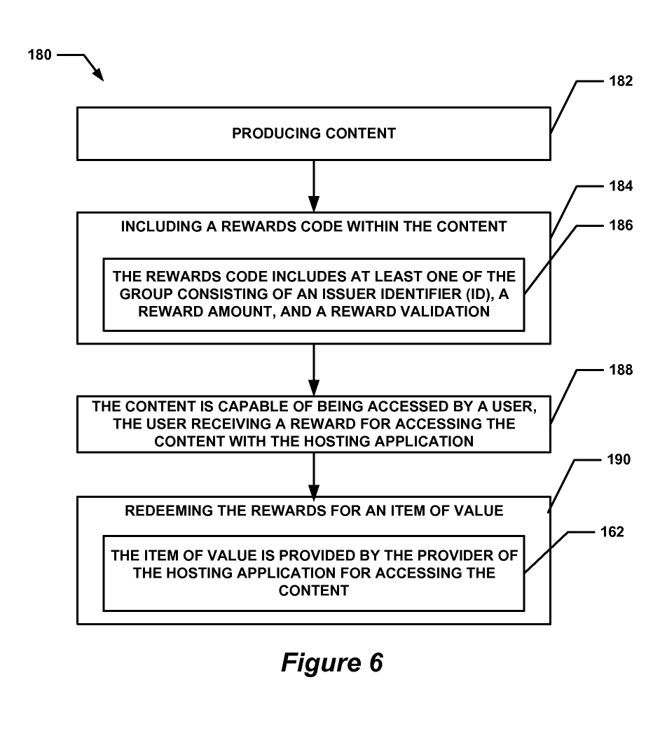

Referring now to FIG. 6, a particular embodiment of a method for rewarding a user of a hosting application 180 is shown. Method 180 starts with processing block 182 which discloses producing content. The content includes text files, image files, audio files, video files, web sites and the like.

Processing block 184 states including a reward code within the content. As shown in processing block 186, the reward code includes at least one of the group consisting of an issuer identifier (ID), a reward amount, and a reward validation. The issuer ID to identify the rewards provider, the reward amount indicates the amount of the award, and the reward validation (e.g., a Message-Digest algorithm 5 (MD5)) is used to ensure the special promotion has not been compromised.

Processing block 188 recites the content is capable of being accessed by a user, the user receiving a reward for accessing the content with a hosting application. The user is prompted by the hosting application to open a reward account (if they haven't signed up), sign in, and is rewarded with a certain number of points the first time the content is viewed. The hosting application reads the specially-coded content, and then credits the points to the user's account.

Processing block 190 states redeeming the rewards for an item of value. Processing block 192 recites wherein the item of value is provided by the provider of the hosting application for accessing the content. Various point redemption selections may be made available to the user. For example, the user can redeem the accumulated points towards a gift card from certain vendors.

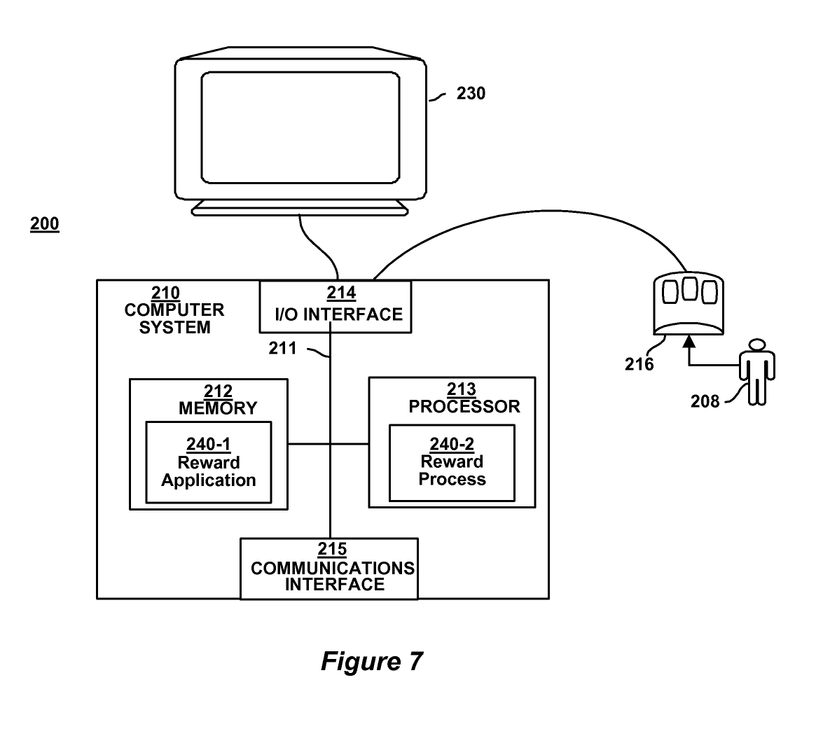

FIG. 7 is a block diagram illustrating an example computer system 200 for implementing rewards function 240 and/or other related processes to carry out the different functionality as described herein.

As shown, computer system 200 of the present example includes an interconnect 211 that couples a memory system 212 and a processor 213 an input/output interface 214, and a communications interface 215.

As shown, memory system 212 is encoded with reward application 240-1. Reward application 240-1 can be embodied as software code such as data and/or logic instructions (e.g., code stored in the memory or on another computer readable medium such as a disk) that support functionality according to different embodiments described herein.

During operation, processor 213 of computer system 200 accesses memory system 212 via the interconnect 211 in order to launch, run, execute, interpret or otherwise perform the logic instructions of the reward application 240-1. Execution of reward application 240-1 produces processing functionality in reward process 240-2. In other words, the reward process 240-2 represents one or more portions of the reward application 240-1 (or the entire application) performing within or upon the processor 213 in the computer system 200.

It should be noted that, in addition to the reward process 240-2, embodiments herein include the reward application 240-1 itself (i.e., the un-executed or non-performing logic instructions and/or data). The reward application 240-1 can be stored on a computer readable medium such as a floppy disk, hard disk, or optical medium. The reward application 240-1 can also be stored in a memory type system such as in firmware, read only memory (ROM), or, as in this example, as executable code within the memory system 212 (e.g., within Random Access Memory or RAM).

In addition to these embodiments, it should also be noted that other embodiments herein include the execution of reward application 240-1 in processor 213 as the rewards process 240-2. Those skilled in the art will understand that the computer system 200 can include other processes and/or software and hardware components, such as an operating system that controls allocation and use of hardware resources associated with the computer system 200.

The device(s) or computer systems that integrate with the processor(s) may include, for example, a personal computer(s), workstation(s) (e.g., Sun, HP), a virtual computer (e.g. VMWare), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the Internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

1. A computer implemented method comprising:
receiving, by a content viewing application executed by a processor, an electronic document having a reward code;
determining, by the content viewing application, a reward account having comprising an account balance;
determining, by the content viewing application, a number of reward points based at least in part on the reward code;
determining, by the content viewing application, to award the number of reward points to the determined reward account based at least in part on the reward code and information related to the determined reward account;
in response to determining to award the number of reward points to the determined reward account, updating, by the content viewing application, the account balance of the determined reward account to include the number of reward points; and
displaying, by the content viewing application, a reward redemption bar for the determined reward account.

2. The method of claim 1 wherein the reward code comprises an issuer identifier (ID), a reward amount, or a reward validation.

3. The method of claim 1 further comprising:
displaying, by the content viewing application, a reward notice in at least a portion of a window in the content viewing application.

4. The method of claim 3 further comprising :
displaying, by the content viewing application, the account balance of the determined reward account in the reward notice.

5. The method of claim 1 wherein determining, by the content viewing application, to award the number of reward points to the determined reward account based at least in part on the reward code or information related to the determined reward account comprises:
in response to determining, by the content viewing application, that the electronic document has not previously been viewed in the content viewing application while the content viewing application is associated with the determined reward account, determining to award the number of reward points to the determined reward account.

6. The method of claim 1 wherein the reward redemption bar is displayed in at least a portion of a window in the content viewing application, and wherein the reward redemption bar provides at least one reward option.

7. The method of claim 6 further comprising in response to receiving a selection of a reward option from the at least one reward option displayed in the reward redemption bar, presenting, by the content viewing application, the selected reward option for printing.

8-11. (canceled)

12. A non-transitory computer readable medium having computer readable code thereon the medium comprising:
computer executable instructions for accessing electronic content with a content viewing application;
computer executable instructions for identifying a reward code within the electronic content; and
computer executable instructions for determining a reward account related to a reward program for a provider of the content viewing application;
computer executable instructions for determining a reward for accessing the electronic content in the content viewing application, the reward based at least in part on the identified reward code;
computer executable instructions for awarding the reward to the determined reward account in response to the electronic content being accessed in the content viewing application; and
computer executable instructions for displaying a reward redemption bar for the determined reward account.

13. The non-transitory computer readable medium of claim 12 wherein the reward code comprises an issuer identifier (ID), a reward amount, or a reward validation.

14. The non-transitory computer readable medium of claim 12 wherein computer executable instructions for awarding the reward to the determined reward account further comprises computer executable instructions for accumulating the reward with at least one previous reward for the determined reward account.

15. The non-transitory computer readable medium of claim 12 further comprising computer executable instructions for redeeming the reward for an item of value.

16. The non-transitory computer readable medium of claim 12 further comprising computer executable instructions for verifying that an author of the electronic content is participating in the reward program for the provider of the content viewing application.

17. The non-transitory computer readable medium of claim 12 wherein computer executable instructions for displaying a reward redemption bar for the determined reward account comprises:
computer executable instructions for displaying at least one gift card reward option in the reward redemption bar.

18. The non-transitory computer readable medium of claim 12 further comprising computer executable instructions for displaying in the content viewing application a reward notice, the reward notice comprising a number of reward points and a reward balance, the number of reward points based at least in part on the reward code, the reward balance indicating an accumulated total of unused reward points.

19-22. (canceled)

23. A computer system comprising:
a memory;
a communications interface; and
a processor in communication with the memory and the communications interface and configured to:
receive electronic content, in a content viewing application, via the communications interface;
identify a reward code within the electronic content;
determine a number of reward points based at least in part on the identified reward code;
determine a reward account related to a reward program for a provider of the content viewing application;
determine whether to award the number of reward points to the determined reward account; and
in response to a determination to award the number of reward points to the determined reward account, updating information related to the determined reward account to include the number of reward points
display a reward redemption bar for the determined reward account.

24. The computer system of claim 23 wherein the determination to award the number of reward points to the determined reward account is based on whether the received electronic content is displayed in the content viewing application.

25. The computer system of claim 23 wherein the determination to award the number of reward points to the determined reward account is based at least in part on whether the received electronic content is authored by a participant in the reward program for the provider of the content viewing application.

26. The method of claim 3 further comprising:
in response to determining to award the number of reward points to the determined reward account, displaying, by the content viewing application, the number of reward points in the reward notice.

27. The method of claim 7 wherein the reward option comprises a gift card.

28. A portable document viewer comprising:
program code for receiving identification information associated with a reward account;
program code for accessing an electronic portable document, the electronic portable document comprising a reward code;
program code for in response to accessing the portable electronic document, determining, by the portable document viewer, whether the electronic portable document or the reward code is associated with the reward account; and
program code for in response to determining that neither the electronic portable document nor the reward code is associated with the reward account:
program code for determining a quantity of reward points associated with the reward code;
program code for awarding the quantity of reward points to the reward account; and
program code for displaying a reward notification indicating the awarding of the quantity of reward points.
